(19) United States
(12) Patent Application Publication
(10) Pub. No.: US 2007/0245329 A1
(43) Pub. Date: Oct. 18, 2007

(54) STATIC ANALYSIS IN DISJUNCTIVE NUMERICAL DOMAINS

(75) Inventors: Sriram SANKARANARAYANAN, PLAINSBORO, NJ (US); Franjo IVANCIC, JERSEY CITY, NJ (US); Ilya SHLYAKHTER, FRANKLIN PARK, NJ (US); Aarti GUPTA, PRINCETON, NJ (US)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC LABORATORIES AMERICA, Princeton, NJ (US)

(21) Appl. No.: 11/692,581

(22) Filed: Mar. 28, 2007

Related U.S. Application Data
(60) Provisional application No. 60/743,849, filed on Mar. 28, 2006.

(51) Int. Cl. G06F 9/45

(52) U.S. Cl. 717/151

(57) ABSTRACT

A computer implemented method for performing a path-sensitive analysis of a computer program using path-insensitive techniques employing an elaboration of the program which advantageously permits a correctness determination of the program as well as a simplification and optimization.

### CROSS REFERENCE TO RELATED APPLICATIONS

This application claims the benefit of U.S. Provisional Application Ser. No. 60/743,849 filed Mar. 28, 2006.

### FIELD OF THE INVENTION

This invention relates to computational methods. More particularly this invention relates to the analysis of software programs and the application of this analysis to produce a path-sensitive result using conventional path-insensitive methods.

### BACKGROUND OF THE INVENTION

Static analysis over numerical domains has been used to check software programs for buffer overflows, null pointer references, division by zero and floating point errors among others. [See, e.g., Wagner, D., Foster, J., Brewer, E., , and Aiken, A. A first step towards automated detection of buffer overrun vulnerabilities. In Proc. Network and Distributed Systems Security Conference (2000), ACM Press, pp. 3-17; Blanchet, B., Cousot, P., Cousot, R., Feret, J., Mauborgne, L., Min_e, A., Monniaux, D., and Rival, X. A static analyzer for large safety-critical software. In ACM SIGPLAN PLDI'03 (June 2003), vol. 548030, ACM Press, pp. 196-207; and Floyd, R. W. Assigning meanings to programs. Proc. Symposia in Applied Mathematics 19 (1967), 19-32]. Numerical domains such as intervals, octagons and polyhedra maintain information about the set of possible values of integer and real-valued program variables along with their inter-relationships. The convexity of these domains makes the analysis tractable. On the other hand, fundamental limitations of convexity lead to imprecision in the analysis, ultimately yielding many false alarms. Elimination of these false alarms is achieved through path-sensitive analysis employing disjunctive domains obtained through power-set extensions. Such extensions can be constructed systematically from the base domain using known techniques [See, e.g., Handjieva, M., and Tzolovski, S. Refining static analyses by tracebased partitioning using control flow. In SAS (1998), vol. 1503 of LNCS, Springer-Verlag, pp. 200-214; Cousot, P., and Cousot, R. Comparing the Galois connection and widening/narrowing approaches to Abstract interpretation, invited paper. In PLILP '92 (1992), vol. 631 of LNCS, Springer-Verlag, pp. 269-295].

Power-set extensions of numerical domains consider a disjunction of predicates at each program location. While these disjuncts help overcome convexity limitations, the complexity of the analysis can still be exponentially higher due to more complex domain operations and also due to the large number of disjuncts that can be produced during the course of the analysis. Furthermore, the presence of disjuncts require special techniques to lift the widening from the base domain up to the disjunctive domain [See, e.g., Bagnara, R., Hill, P. M., and Zaffanella, E. Widening operators for powerset domains. In Proceedings of the Fifth International Conference on Verification, Model Checking and Abstract Interpretation (VMCAI 2004) (2004), vol. 2947 of LNCS, pp. 135-148].

Controlling the production of disjuncts during the course of the analysis is one of the key aspects of managing the complexity of the analysis. The design of such strategies can be performed by techniques that annotate data flow objects by partial trace information such as trace partitioning, and other path sensitive data-flow analysis techniques that implicitly manage complexity by joining predicates only when the property to be proved remains unchanged as a result, or “semantically” by careful domain construction [See, e.g., Bagnara, R., Hill, P. M., and Zaffanella, E. Widening operators for powerset domains. In Proceedings of the Fifth International Conference on Verification, Model Checking and Abstract Interpretation (VMCAI 2004) (2004), vol. 2947 of LNCS, pp. 135-148; and Manevich, R., Sagiv, S., Ramalingam, G., and Field, J. Partially disjunctive heap abstraction. In Static Analysis Symposium (SAS) (2004), vol. 3148 of LNCS, Springer-Verlag, pp. 265-279].

### SUMMARY OF THE INVENTION

According to an aspect of the invention, a path-sensitive program analysis is achieved through the use of path-insensitive techniques.

More particularly, according to the present invention fixed points computed over power-set extensions correspond to fixed points over a base domain computed on an “elaboration” of the CFG. As a result, the complexity of path-sensitive analysis can also be controlled by means of a strategy for producing elaborations of the CFG being analyzed.

Accordingly we demonstrate analysis techniques according to the present invention that perform the fixed point iteration hand in hand with the construction of the elaboration that characterizes the fixed point (On-The-Fly). As an application, we consider bounded elaborations, that correspond to power-set extensions wherein the number of disjuncts in each abstract object is bounded by a fixed number K. We discuss the implementation our ideas in a light weight static analyzer for the C language as a part of the F-Soft project and demonstrate results.

One advantage of the elaboration approach of the present invention is that it provides a connection between the disjuncts in a power-set domain and the syntactic connections between them in a trace partitioning scheme.

### BRIEF DESCRIPTION OF THE DRAWING

A more complete understanding of the present invention may be realized by reference to the accompanying drawings in which:

FIG. 1 is simple flow diagram showing disadvantages associated with prior-art static analysis techniques;

FIG. 2a and FIG. 2b are simple flow diagrams showing the flow diagram of FIG. 1 and its elaboration FIG. 2b;

FIG. 3 is simple flow diagram depicting a fixed point obtained on a power-set extension according to the present invention;

FIG. 4 shows an example program and the invariants computed using the octagon domain; a

FIG. 5a shows that an elaboration of a CFG C is another CFG E according to the present invention;

FIG. 5b shows replication relationships between CFG C and an elaboration CFG E according to the present invention;

FIG. 5c shows a CFG from an example along with an elaboration;

FIG. 5d shows an additional example of an elaboration according to the present invention;

FIG. 5e shows yet another example of an elaboration according to the present invention;

FIG. 6 shows an exemplary bounded disjunctive elaboration according to the present invention;

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

Before discussing the present invention, the following definitions will provide the reader with the proper context.

Data flow analysis discovers “facts” that hold true at different program locations.

Example:

int i=0;
for (i=0; i < 100; ++i)

/*-- Fact: 0 <= i and i <= 100 --*/

...

A Dataflow analysis can answer specific questions about the programs behaviour. Examples include:

(a) Constant folding analysis: Is the value of some variable always a constant at some program location? If so, what is it?

(b) Interval analysis: Compute some safe intervals inside which the value of variables lie at a program location.

(c) Octagon analysis: What are the bounds on the pairwise differences of variables.

(d) Pointer analysis: What memory locations can a particular pointer point to at some program location.

In general, answering these questions exactly is not possible because of undecidability. Therefore, we seek sound (conservative) answers. A sound answer to a data flow problem is one which takes into account every possible real program behaviour and more (some behaviors may be spurious).

Example:

(a) Interval analysis: Suppose variable x actually lies in the interval [0,100], it is sound for our interval analysis to infer that x lies in the interval [−100,101]. But it is *unsound* to infer that x lies in the interval [0,50], because in reality, the program may actually exhibit the value 100 which our analysis does not take into account.

(b) Pointer analysis: A sound pointer analysis should include all the memory locations that a pointer may actually point to. It may include other locations too.

A key metric for dataflow analysis algorithm is their precision. The precision of an analysis is measured by how close the answer comes to being as exactly as possible.

Example:

Interval analysis: The least precise interval that holds trivially is that a variable can have any possible value in the interval [−infinity, infinity]. Such an interval is computed trivially and is useless for all practical purposes. The most precise interval cannot be computed by an algorithm due to undecidability. In practice, we try to approach as close to this most precise interval as possible, but remaining sound at the same time.

Data flow analysis problems may be classified in many ways:

(a) Flow-sensitive/insensitive dataflow:

A flow sensitive dataflow algorithm computes different facts at different locations of the program. On the other hand, a flow-insensitive algorithm computes one single fact that holds true for the program as a whole, regardless of where the control resides.

(b) Context-sensitive/insensitive:

When a program is executed, we define the current context of a program as a sequence of function calls from the main function that leads us to the current program point. A context sensitive dataflow algorithm tracks different contexts (function calls) by which a particular program point may be reached. The results of such an algorithm are predicated by what context a location is reached in.

int f(int x){

print(x); /*--

context: main --> g --> f, fact: x = 0 ,
context: main --> h --> f, fact: x = 2

--*/

}
int g(int x){

f(x); /*-- context: main --> g: fact: x = 0 --*/

}
int h(int x){

f(x+1); /*-- context: main ---> h: fact: x =1 --*/

}
int main(int x){

if (x == 0)

g(x);

if (x == 1)

h(x);

return;

}

(c)Path-sensitive/insensitive: The analysis is sensitive to some aspects of the path taken to reach a location.

Example:

int y;
if (x > 0) /*-- branch B1 --*/

y=0;

else

y=1;

Path insensitive interval analysis will infer

y in [0,1]

Path sensitive interval analysis:

branch B1, then branch --> y in [0,0]

branch B1, else branch --> y in [1,1]

Perfect path sensitivity is very hard to achieve (expensive) in practice. Therefore, practical path sensitive algorithms may be partially path sensitive. That is, they may be sensitive to some aspects of the path while insensitive to others.

Note: Path/context sensitivity are independent in practice. We may have context insensitive algorithms that may be partially path sensitive. We may have a context sensitive algorithm that is path sensitive. But a perfect path sensitive algorithm is always context sensitive.

By way of additional background, it is noted that path-sensitivity is one significant drawback associated with static analysis techniques. And while path-insensitive static analysis techniques are more scalable, this scalability comes at the cost of accuracy, i.e., the analysis produces a number of false alarms.

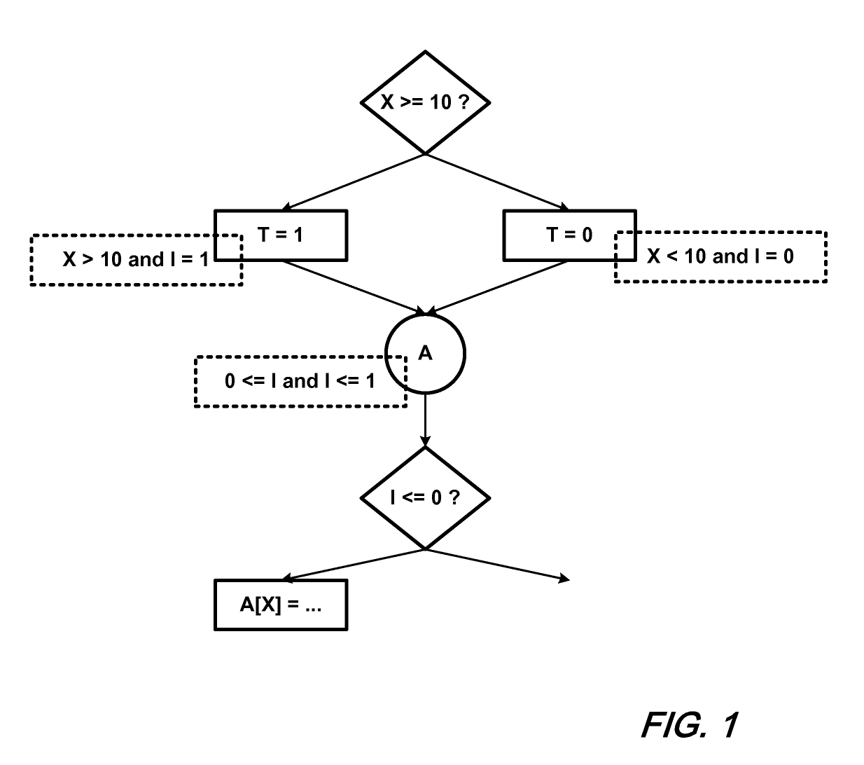

With initial reference to FIG. 1, there is shown a flow diagram of a simple program. As can be observed, the invariants computed by a simple flow-sensitive but path-insensitive linear relations analysis are shown next to each node (in dotted boxes). A path insensitive-analysis merges the data-flow information at node A, thereby missing the relation between the values of I, X at this point. Such an analysis may not be able to prove the safety of the array access A[X]. Thus, we need to consider analysis using a disjunction of data-flow predicates at each program location. There are at least two distinct approaches to this problem.

Powerset Extensions

Powerset extensions of a base domain enrich the domain by considering disjunctions of the domain objects as the new data flow objects. The domain operations on such extensions can be defined readily in terms of the operations on the base domain. Widening operations on this domain can also be defined in terms of the extensions on the base-domain objects.

The advantage of a powerset extension is that it can be done independently of the base domain. On the other hand, powerset extensions are practically expensive. For numerical domains such as octagons and polyhedra, program analysis using these extensions are exponentially more expensive than in the base domain. Furthermore, the requirement of widening to enforce termination means that heuristic operators are required over the base domain widening. The impact of these operators on the precision of the analysis are not well characterized. For instance, a powerset extension of the polyhedral domain analyzes the program of FIG. 1 by not merging the data flow objects incoming at the join point A.

Trace Partitioning Techniques

Trace partitioning techniques are aimed at performing a flow-sensitive analysis using the base-domain operations. Such algorithms typically associate multiple abstract objects with each CFG location. Each object carries some trace information on the paths that were used to create them. In order to limit this complexity, these objects may be merged heuristically, merging the historical trace information associated with them. Approaches that fall in this category typically differ in their use of heuristics.

According to the present invention, we show a connection between the result of a static analysis on any powerset extension to the result of the static analysis carried out in the base domain on an “elaboration” of the CFG. As a result, we show that the design of the powerset extension can be thought of as the design of the elaboration scheme.

We demonstrate an analysis method that creates the elaboration hand-in-hand as it carries out the analysis on the base-domain. The advantage of the elaboration based approach is that it gives a connection between the semantic connection between the disjuncts in a power-set domain an the syntactic connections between them in a trace-partitioning scheme. Furthermore, since the notion of an elaboration is more general than a trace partitioning, it provides more freedom in the design of the analysis.

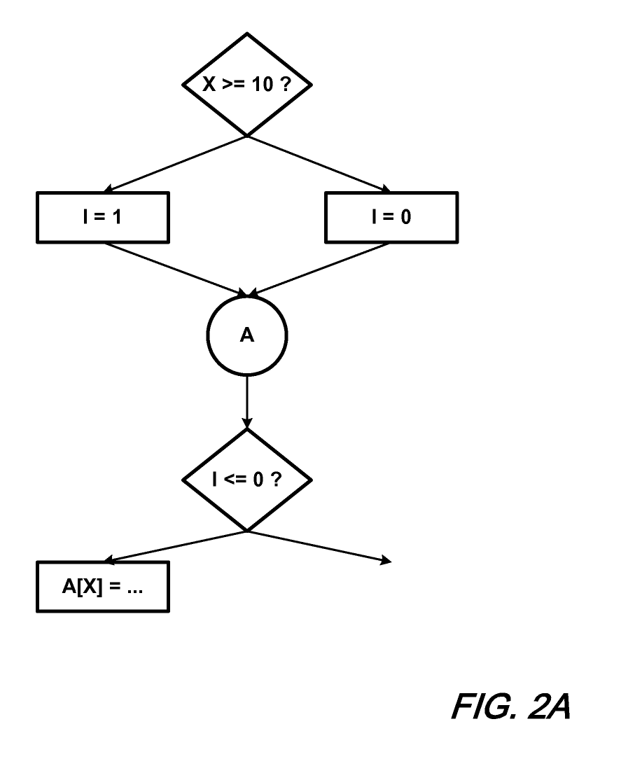

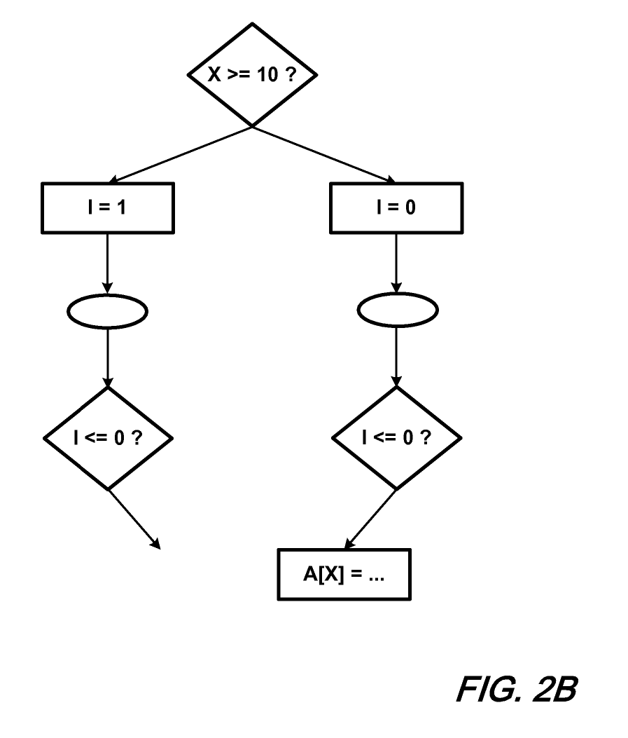

FIG. 2a shows a flow diagram of the program of FIG. 1 with an elaboration of the flow diagram (FIG. 2b). Note that a base domain analysis on the elaboration of the flow diagram may prove the safety of the array access to A.

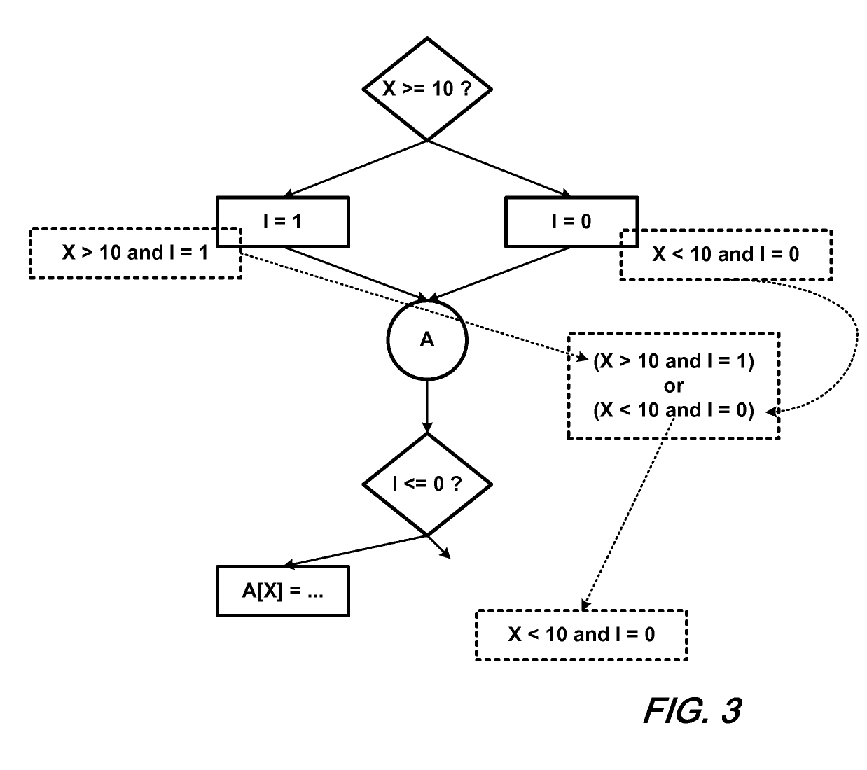

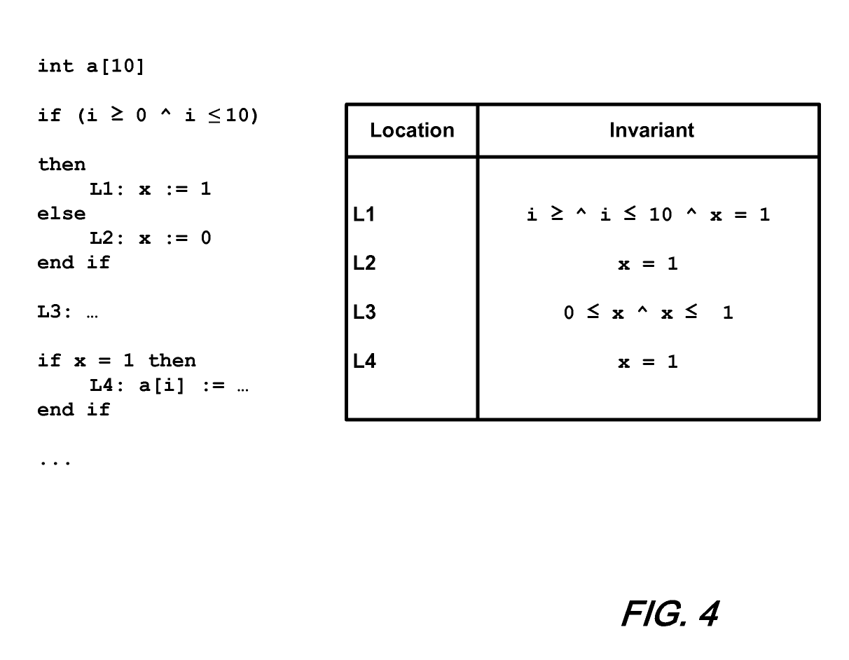

With reference to FIG. 3, there is shown a flow diagram depicting the fixed point obtained on a powerset extension. Note that the presence of the disjoint at point A enables the analysis to prove freedom from overflows. Also note that the elaboration shown is implicit in the source of the disjuncts—which are shown in dotted lines.

In describing the present invention, we first present basic notions of abstract interpretation and the polyhedral domain, which is used as the representative numerical domain.

Programs and Invariants

Since we focus on static analysis over numerical domains, we may regard programs as purely ranging over integer or real-valued variables. Accordingly, we let V={x₁, . . . , Xₙ} denote integer-valued program variables, collectively referred to as \vec{x}. The program operations over these variables include numerical operations such as addition and multiplication.

We assume first-order predicates over the program state belonging to an appropriate language. Given such a predicate ψ, the set of valuations to \vec{x} satisfying is denoted [[ψ]]. A program is represented by its Control-flow graph (CFG).

Def. 2.1 (Control-flow Graphs (CFGs)). Formally, a CFG is a tuple Π:(V,L,T,l₀,Θ):
L: a set of locations (cutpoints);
T: a set of transitions (edges), where each transition τ: l₁→lⱼ is an edge between the pre-location lᵢ and a post-location lⱼ. Each transition models the changes in the values of program variables using guards and updates.
lₒ∈L: the initial location; Θ is an assertion over \vec{x} representing the initial condition.

A state s of the program maps each variable xᵢ to an integer value s(xᵢ). Let Σ denote the set of program states. An assertion ψ over \vec{x} is an invariant of a CFG at location l if and only if it is satisfied by every state reachable at l. An assertion map associates each location of a CFG to predicate. An assertion map η is invariant if η(l) is an invariant, for each l∈L. The (concrete) post condition post_{Σ}(φ,τ) of an assertion φ across a transition τ models the effect of executing τ on each state satisfying φ. Invariants are established using known inductive assertions method [See, e.g., Manevich, R., Sagiv, S., Ramalingam, G., and Field, J. Partially disjunctive heap abstraction. In Static Analysis Symposium (SAS) (2004), vol. 3148 of LNCS, Springer-Verlag, pp. 265-279].

Def. 2.2 (Inductive Assertion Maps). An assertion map η is inductive if an only if it satisfies the following conditions:

Initiation: Θ

[symbol]

[symbol]

Consecution: For each transition τ: lᵢ [symbol] lⱼ,

post_{Σ}

[symbol]

It is well known that any inductive assertion map is invariant. However, the converse need not be true. The standard technique for proving an assertion invariant is to find an inductive assertion that strengthens it.

Abstract Interpretation

Abstract interpretation [See, e.g., Cousot, P., and Cousot, R. Abstract Interpretation: A unified lattice model for static analysis of programs by construction or approximation of fixpoints. In ACM Principles of Programming Languages (1977), pp. 238-252] is a generic technique for computing inductive assertions of CFGs using an iterative process. In order to compute an inductive map, we start from an initial map and repeatedly weaken the predicates mapped at each location to converge to a fixed point. The assertions labeling each location can be shown to be inductive when the fixed point is reached.

Abstract Domain.

In order to carry out an abstract interpretation, we define an abstract domain along with some operations on the elements of the abstract domain known as the domain operations. Informally, an abstract domain is a lattice of predicates Γ over the program state including the assertions T and ⊥ representing true and false respectively. The domain is defined by the abstract lattice [symbol] and the concrete lattice of sets of program states ordered by inclusion z,4 along with the abstraction function α:2^{Σ} [symbol] Γ and the concretization (or the meaning) function γ:Γ [symbol] →2^{Σ}. A key requirement is that α,γ form a Galois connection (see [6, 8] for comprehensive surveys). The abstract domain operations include:

Join Given abstract objects d₁, . . . , dₘ, we construct an abstract object d:d₁␣ . . . ␣dₘ such that dᵢ [symbol] d.

Meet (Intersection) Given abstract objects d₁, . . . , dₘ, we construct an object d:d₁ [symbol] . . . [symbol] dₘ such that d [symbol] dᵢ, 1≦i≦m.

Post-Condition Given an abstract object d and a transition τ, we compute its abstract condition d′: post_{Γ}(d,τ) such that
post_{Σ}(γ(d),τ) [symbol] γ(d′).

Note that if the domain is clear from context, we drop the subscript from the post-condition.

Inclusion Test Given objects d₁ and d₂, decide if d₁ [symbol] d₂.

Widening Given abstract d₁, d₂ such that d₁ [symbol] d₂ their widening d:d₁∇d₂ over-approximates the join operation, i.e., d₁␣d₂ [symbol] d. Furthermore, repeated applications of widening on an increasing sequence of abstract objects, guarantees convergence to a fixed point in a finite number of iterations. Other operations of interest include projection, which is commonly used to eliminate variables that are out of scope in the interprocedural analysis.

Forward Propagation. An abstract assertion map η:L [symbol] Γ labels CFG location l with an abstract object η(l)∈Γ. An abstract assertion map η is inductive iff the map [symbol] is an inductive assertion map. Given a CFG Π along with an abstract domain Γ, forward propagation seeks to construct an inductive abstract assertion map, iteratively as follows:

Initial Step The initial map η⁽⁰⁾ is defined as follows:

$${η}^{( 0 )} ( {l}_{0} ) = \{ \begin{matrix}Θ , l = {l}_{0} \\ ⊥ , otherwise\end{matrix}$$

Iterative Step The iterative step computes the join of the current assertion at a location [symbol] with the post-condition of all its incoming transitions.

$${η}^{( i + 1 )} ( ℓ ) = {η}^{( i )} ( ℓ ) ⊔ \\ {⊔}_{{T}_{j} : {l}_{j} \to ℓ} {post}_{Γ} ( {η}^{( i )} ( {ℓ}_{j} ) , {τ}_{j} ) .$$

For convenience, we denote this as [symbol] Note that ℑ is monotonic w.r.t [symbol] , i.e., [symbol] for all

[symbol]

Convergence Convergence occurs if [symbol] for each l∈L .

Given an initial map [symbol] until convergence [symbol] Such a map is a fixed point w.r.t [symbol] It can be shown that a fixed point map is also inductive. Hence, if the forward propagation converges, its results in an inductive assertion at each cutpoint. Convergence is guaranteed in finitely many iterative steps if the domain sastifies the ascending chain condition. Examples of such domains include finite domains and notably the domain of linear equalities. On the other hand, domains such as intervals and polyhedra do not satisfy this condition. Hence, the widening operation ∇ is used repeatedly to force convergence in finitely many steps.

Numerical Domains.

Numerical domains such as intervals, octagons and polyhedra reason about the values of integer or real-valued program variables. These domains are widely used to check programs for buffer-overflows, null pointer dereferences, division-by-zero, floating point instabilities [See, e.g., Cousot, P., and Cousot, R. Abstract Interpretation: A unified lattice model for static analysis of programs by construction or approximation of fixpoints. In ACM Principles of Programming Languages (1977), pp. 238-252].

The interval domain consists of interval predicates of the form [symbol] ∈[lᵢ, uᵢ,] with the possibility of open intervals. The complexity of the domain operations is linear in the number of variables. Analysis techniques for this domain have been widely studied. The octagon domain due to Miné consists of assertions of the form [symbol] ±xᵢ±xⱼ≦c along with interval constraints over the variables. The nature of the constrains in this domain permits a graphical representation and the computation of many domain operations using the shortest path algorithm as a primitive. The operations in this domain are at most cubic in the number variables. The polyhedral domain consists of convex polyhedra over the program variables represented by the constrains of the form [symbol] +α₁x₁+ . . . +αₙxₙ≧0. Domain operations over this domain are expensive (exponential space in the size of the polyhedra). However, relaxations of the operations and the structure of the constraints in the domain can yield polynomial time approximations to these operations [See, e.g., Cousot, P., and Halbwachs, N. Automatic discovery of linear restraints among the variables of a program. In ACM POPL (January 1978), pp. 84-972].

One of the key properties of these domains is that of convexity which limits the ability of these domains to represent sets of states. For instance, a convex numerical domain over x₁,x₂ including points A and B, representing program states necessarily includes states that lie on the line joining these two points. Such a drawback leads to cases wherein the domain is unable to compute an invariant that proves the property of interest.

Example 2.1. FIG. 1 shows a simple program that checks for a condition, storing its result in a variable x. Later that result is used in lieu of check the condition again. The table to the right shows the invariants computed after each labeled location. Note that the invariant i≦10, required L4 to prove the absence of overflows, cannot be established. Even though the program is free from overflows, convex numerical domains will not be able to establish the required invariants to prove correctness.

On the other hand, convexity is desirable since it makes the domain operations tractable. The problem can be avoided using powerset extensions.

Powerset Extensions

Given a base abstract domain of predicates, a powerset extension of the domain consists of disjunctions of the base domain predicates. Assume the concrete domain [symbol] consisting of subsets of program states along with a base abstract domain [symbol] and functions α,γ representing the abstraction and concretization. We shall assume that all the domain operations are computable in the base domain.

Def. 3.1 (Powerset extension). A powerset extension of an abstract domain [symbol] is given by the domain [symbol] such that
\hat{Γ}={S= [symbol] dᵢ∈Γ, m≧0}.

Without loss of generality, we may require that the domain be redundancy free, i.e., no disjuncts in a predicate is subsumed by any other disjuncts. Formally, for any set S∈\hat{Γ}
(∀,d₂∈S)(d₁≠d₂) [symbol] (d₁ [symbol] d₂).

The concretization function \hat{γ} for a powerset extension is defined as [symbol] The ordering relation [symbol] may be defined in many ways to derive different extensions. However, any such definition needs to be faithful to the semantics induced by \hat{γ}, i.e. if S₁ [symbol] S₂ then \hat{γ}(S₁) [symbol] \hat{γ}(S₂).

Extending Partial Orders. The natural powerset extension is obtained by considering [symbol] such that S₁ [symbol] NS₂ iff \hat{γ}(S₁) [symbol] \hat{γ}(S₂). This is the partial order induced by the concrete domain on the abstract domain through \hat{γ}. The Hoare powerset extension [symbol] P is a partial order defined as follows:

[symbol]

Informally, we require that every object in S₁ be “covered” by some object in S₂. This can be refined to yield a Egli-Milner type partial order [symbol] EM.

S₁ [symbol] S₂ [symbol] S₁=Ø or (S₁ [symbol] PS₂ and (∀d₂∈S₂)(∃d₁∈S₁)d₁ [symbol] d₂).

In addition to S₁ [symbol] S₂, each element in S₂ must cover some element in S₁.

Example 3.1. Consider the interval domain [symbol] over variables x₁,x₂. Let S₁={φ₁:x₁∈[0,1]} and S₂= [symbol] :x₁∈[−1,½]}, it is easily seen that S₁ [symbol] S₂, however S₁ [symbol] (not) pS₂ since each element of S₂ is incomparable with the element in S₁.

On the other hand let S₃={ξ₁:x₁∈[0,2],ξ₂:x₁∈[−1,0]}. Note that S₁ [symbol] pS₃ since φ₁ [symbol] ξ₁. On the other hand ξ₂ does not cover any object in S₁, hence S₁ [symbol] (not) EMS₃.

Consider the interval domain [symbol] of conjunctions of closed, open and half open intervals over the program variables and its natural powerset extension [symbol] It is computationally hard to decide the [symbol] relation.

Theorem 3.1. Given S₁,S₂∈Î, deciding if S₁ [symbol] S₂ is so co-NP-hard.

Proof. We perform a reduction from the problem of proving universality of DNF formulas. We introduce one variable xᵢ corresponding to each position pᵢ. The literal pᵢ is represented by the predicate xᵢ∈[0,∞) and [symbol] by xᵢ∈(−∞,0). Each DNF clause translates into an interval domain predicate [symbol] ∈ [symbol] . Therefore the validity of the propositional formula can be reduced to checking the inclusion {T} [symbol] {T(D₁), . . . ,T(Dₘ)} wherein T(Dᵢ) represents the interval predicate modeling the DNF clause Dᵢ.

The hardness of [symbol] extends to natural powerset extensions of most numerical domains and many non-numerical domains that are sufficiently powerful to enable the translation above. Other partial orders [symbol] and [symbol] are easier to compute using O(|S₁|+|S₂|)² many base domain [symbol] comparisons.

The domain operation is a powerset domain can be defined by suitably lifting the base domain operations. Notably, the join operation in a powerset domain reduces to a set union. The meet operation S₁ [symbol] S₂ is given by the pairwise meet of elements from S₁,S₂. Post condition is computed element-wise; i.e., if S={d₁, . . . , dₖ}∈

[symbol]

\hat{post}(S,τ)={post(d₁,τ), . . . , post(dₖ,τ)}.

Widening operations can be obtained as extensions of the widening on the base domain using carefully crafted strategies. Such operators over powerset extensions of numerical domains widen over the [symbol] ordering. Thus, even if a domain were designed to use joins over the [symbol] ordering, the final fixed point could be obtained by using the [symbol] or the [symbol] ordering.

Example 3.2. Consider the program below:

s := −1
while... do

s := −s{invariant : (s = 1 [symbol] s = −1)}

end while

The invariant s=1 v s=−1 is a fixed point in the powerset extension of the interval domain using the [symbol] ordering.

CFG Elaboration

We now prove a simple connection between the fixed point obtained on a domain [symbol] using the forward propagation on a CFG Π and the fixed point in the base domain using the notion of an “elaboration”. Intuitively, an elaboration of CFG replicates each location of the CFG multiple times. Each such replication preserves all the outgoing transitions from the original location.

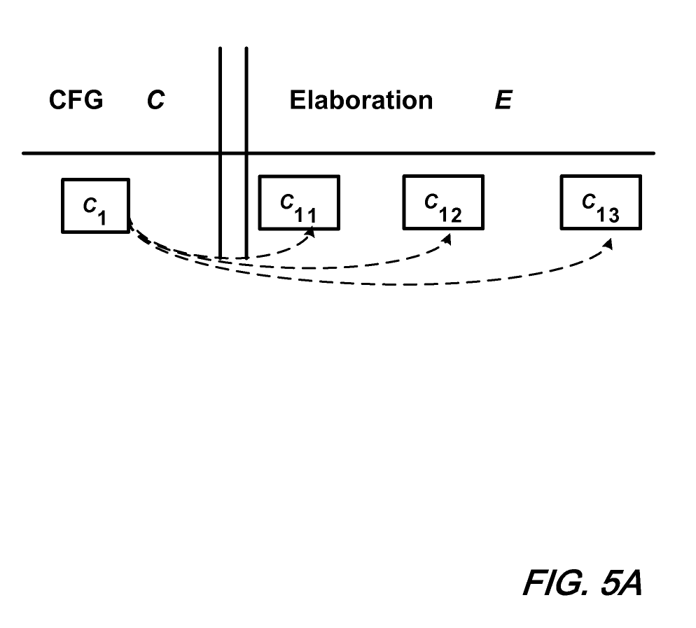

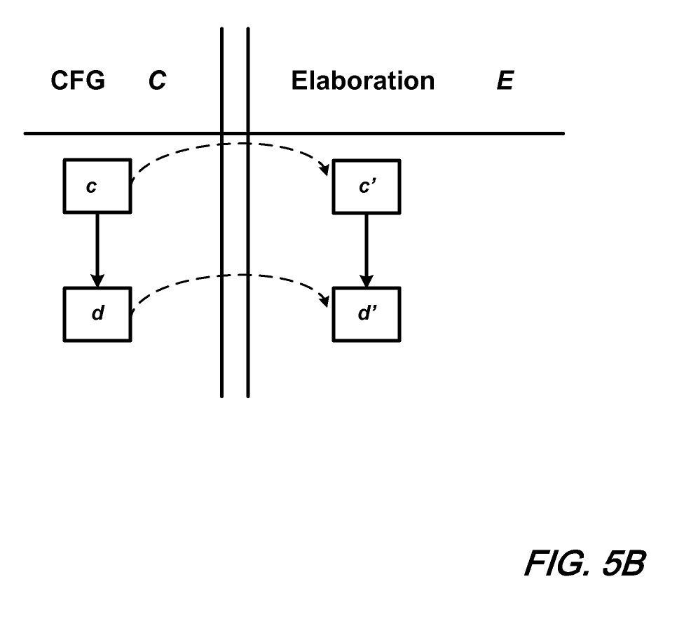

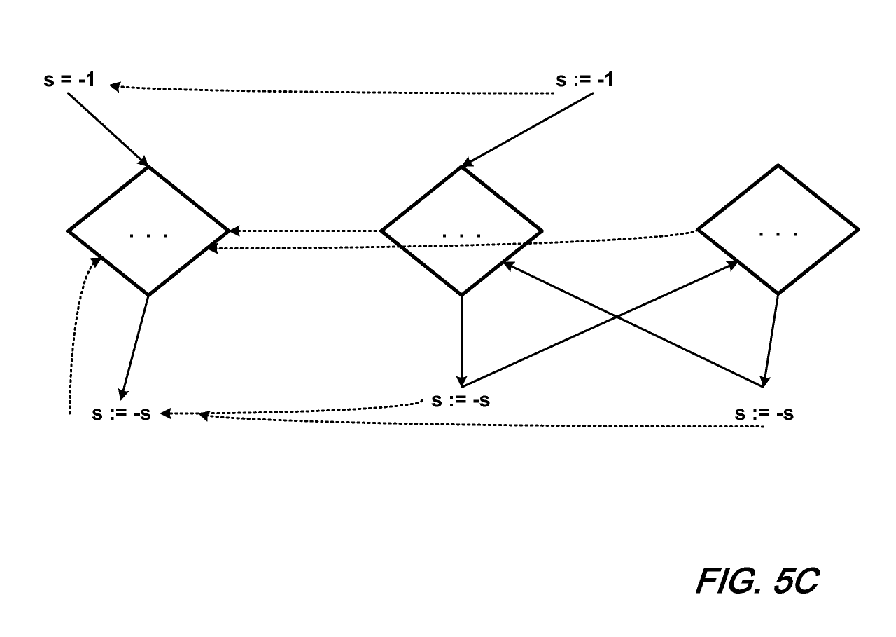

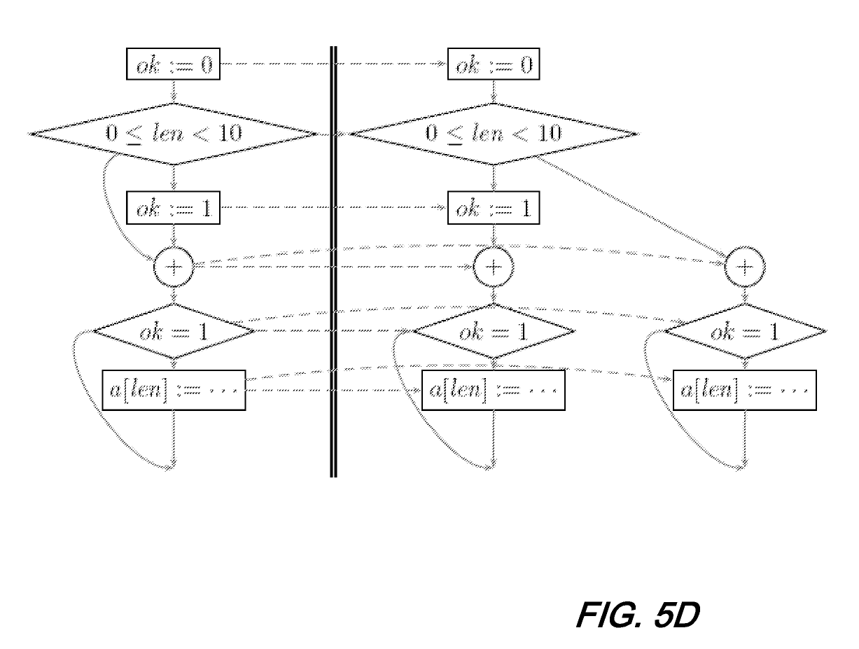

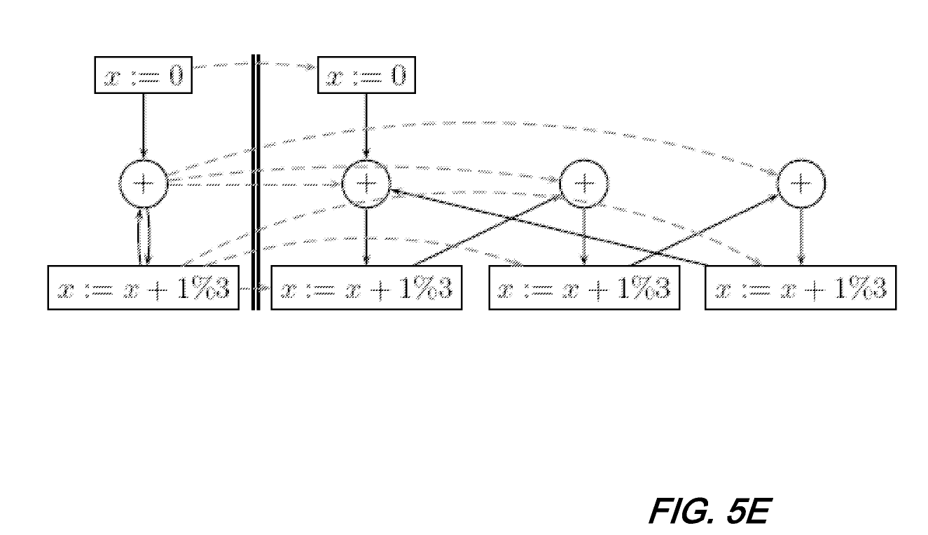

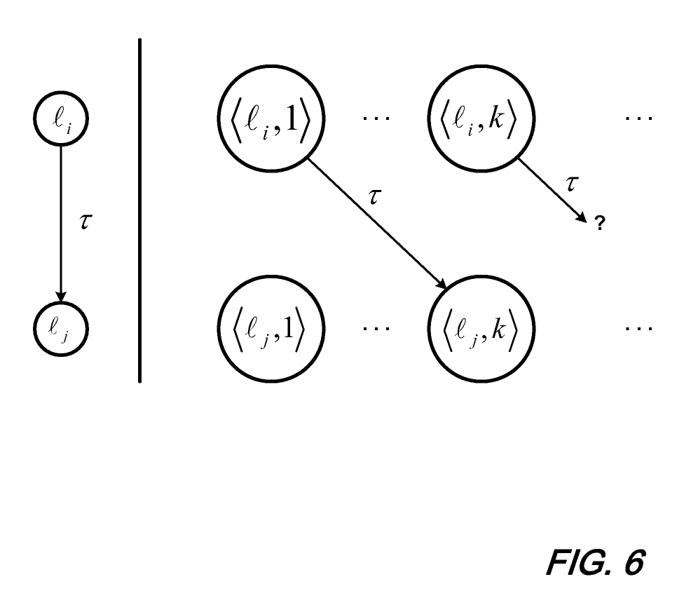

An elaboration of a CFG C is another CFG E. That is to say, for each node c present in C, there are some replications in E. This is shown schematically in FIG. 5a.

Continuing, and with particular reference to FIG. 5b, forall c→d in C and for each replication c′ in E, there is an edge c′→d′ such that d′ replicates d

Def. 3.2. Consider CFGs Πₑ: [symbol] and Π [symbol] over the same set of variables V. The CFG Πₑ is an elaboration of Π iff there exists a map p:Lₑ [symbol] L such that
The initial location in Πₑ maps to the inital location of Π: [symbol]
Consider locations [symbol] Π and [symbol] such that [symbol] For each outgoing transition [symbol] there is an outgoing transition [symbol] such that p(mₑ)=m.

Each [symbol] ∈Lₑ is said to be a replication of p [symbol] ∈L . Note that every outgoing transition of p [symbol] is replicated in [symbol] We denote the replication of the transition [symbol] starting from [symbol] as [symbol] An elaboration resembles a (structural) simulation relation between Πₑ and Π.

Example 3.3. FIG. 5 shows a CFG Π from Example 3.2 along with an elaboration. The dashed line shows the relation p.

We shall now prove that every fixed point assertion on a powerset domain [symbol] on a CFG Π corresponds to a fixed point in the base domain [symbol] on some elaboration Πₑ and vice-versa.

Def. 3.3 (Collapsing). Let ηₑ:Lₑ [symbol] Γ be a fixed point map on the elaboration Πₑ in the base domain. Its collapse C(ηₑ) is a map on the original CFG, L [symbol] \hat{Γ} such that for each

[symbol]

z,69

The collapsing operator computes the disjunction of the domain objects at each replicated location.

Lemma 3.1. If ηₑ is a fixed point for Πₑ in the domain Γ then C(ηₑ) is a fixed point map for Π in the domain \hat{Γ}.

Proof. (Sketch) For convenience we denote ηₑ=C(ηₑ). It suffices to show initiation [symbol] and consecution for each transition [symbol] , we require [symbol] Initiation is obtained by nothing that initial states must be replicated in an elaboration. Expanding the definition for LHS,

$$\begin{matrix}{post}^{} ( {η}_{c} ( {ℓ}_{i} ) , τ ) = {post}^{} ( \{ {η}_{e} ( {ℓ}_{e} ) \vert p ( {ℓ}_{e} ) = {ℓ}_{i} \} , τ ) \\ = \{ post ( \{ {η}_{e} ( {ℓ}_{e} ) , τ \vert p ( {ℓ}_{e} ) = {ℓ}_{i} \} )\end{matrix}$$

Similarly the RHS is expanded [symbol] In order to show the containment, note that an elaboration requires that [symbol] should be an outgoing transition fore each replication lᵢₑ with [symbol] with [symbol] Using the fact that ηₑ is a fixed point map, we note that each element [symbol] on the LHS is contained in the element [symbol] from the RHS.

Conversely, the fixed point in [symbol] induces an elaboration of the CFG.

Def. 3.4 (Induced Elaboration). Let [symbol] be a fixed point map for Π in the domain [symbol] Such a fixed point induces an elaboration Πₑ and an induced map ηₑ defined as follows:
Locations: Let [symbol] ={d₁, . . . , dₘ}. The elaboration contains replicated locations [symbol] , . . . , [symbol] ∈Lₑ, one per disjuncts such that [symbol] Further the map [symbol]
Transitions: For each transition [symbol] we require an outgoing transition [symbol] for some l. We make this choice directly based on the proof of consecution of η under [symbol] Let [symbol] ={α₁, . . . , αₘ} and η(lⱼ)={β₁, . . . , βₙ} (Note that we may represent the empty set equivalently by the singleton {⊥}). The post condition [symbol] ={post [symbol] |1≦k≦m}. By definition of [symbol] order, we require for each [symbol] for some 1≦l≦n. As a result, we replicate the outgoing transition [symbol] in Πₑ to connect [symbol] to [symbol] . It immediately follows that ηₑ satisfies consecution for this transition. Not that since this choice is not unique, there may be many induced elaborations.

Example 3.4. The elaboration shown in Example 3.3 is induced by the fixed point shown in Example 3.2.

Lemma 3.2. Given a fixed point map η_{c} for Π in the domain [symbol] its induced map ηₑ is a fixed point for the induced elaboration Πₑ in the base domain

[symbol]

Proof The proof follows from the definition above.

An elaboration Πₑ is said to be connected if every location [symbol] Lₑ is reachable from the initial location [symbol] . By a process of removing unnecessary disjuncts from a fixed point for the original CFG, it can be shown that the induced elaboration Πₑ is connected.

On-the-Fly Elaborations

In the previous section, we have demonstrated a close connection between fixed point in a broad class of powerset domains and the fixed point in the base domain computed on a structural elaboration of the original CFG. As a result, analysis in powerset domains can be reduced to the process of an analysis on the base domain carried out on some CFG elaboration. As a caveat, we observe the even though it is possible to find some elaboration that produces the same fixed point as in the powerset extension with some widening operator, an apriori fixed elaboration scheme may not be able to produce the same fixed point on all CFGs.

In order to realize the full potential of a powerset extension, the process of producing an elaboration of the CFG needs to be dynamic by considering partial elaborations of the CFG as the analysis progresses. Such a scheme can be viewed as a powerset extension wherein the containment relations between the individual disjuncts in a predicate are explicitly depicted.

The main advantage of such a scheme is the widening on the partially elaborated CFG can be performed by simply using the base-domain widening. Furthermore, the structure of the elaborated CFG can be used to make fine grained optimizations such as avoiding unnecessary widenings on replicated loops by dynamically tracking loop structures. We now consider a scheme for producing elaborations on-the-fly during the analysis process.

Partial Elaboration A partial elaboration Πₑ,U of a CFG Π: L,, [symbol] is a tuple consisting of a CFG Πₑ: L_{e,e,} [symbol] and an unresolved set U [symbol] Lₑx of pairs, each consisting of a location from Πₑ and a transition from Π. As with a CFG elaboration, each location [symbol] Πₑ is a replication of some location [symbol] Π. Furthermore, for each transition [symbol] Π and each [symbol] ∈Lₑ replicating [symbol] exactly one of the following holds:
There exists a replicated transition [symbol] , or else,

[symbol]

In other words, U contains all the outgoing transitions of Π which have not been replicated in a given location of Πₑ. A partial elaboration is a (complete) elaboration iff U=Ø. Given a CFG Π, an initial partial elaboration Πₑ⁰ is given by Lₑ⁰={l₀},ₑ=Ø and U={l₀,τ|τ:l₀→lᵢ}; in other words, the initial location of Π is replicated exactly once and all its outgoing transitions are unresolved. Two basic transformations are permitted on a partial elaboration:
Location Addition: We add a new location [symbol] to Lₑ replicating some node p [symbol] ∈L, i.e., Lₑ=Lₑ [symbol] Furthermore, all transitions in outgoing from [symbol] are treated as unresolved, i.e, [symbol]
Transition Resolution: Given a pair [symbol] we replicate [symbol] in Πₑ as [symbol] for some replication [symbol] of the target location

[symbol]

Our analysis at each stage consists of a partial elaboration Πₑ⁽ⁱ⁾,U⁽ⁱ⁾ along with an abstract assertion map η⁽ⁱ⁾:Lₑ [symbol] Γ. Each iteration involves an update to the map η⁽ⁱ⁾ followed by an update to the partial elaboration.

Consider an unresolved entry [symbol] Its resolution involves the choice of a target node [symbol] replicating [symbol] Let d:(η⁽ⁱ⁾ [symbol] denote the result of the post condition of the unresolved transition. Furthermore, let [symbol] ∈=Lₑ denote the existing replications of the target location [symbol] and [symbol] denote the k^{th} disjunct. The choice of a target location for the transition [symbol] depends on the post condition d and the assertions d₁, . . . , dₘ. The target can either be chosen from the existing target replications [symbol] or a new node [symbol] can be added as a new replication of the target. We shall assume a merging heuristic MergeHeuristic (d, d₁, . . . , dₘ) to compute the index i s.t. 1≦i≦m+1 for the target location of the transition.

Formally, at each step we first update the map η⁽ⁱ⁾=(η⁽ⁱ⁻¹⁾ as described in Section 2. The partial elaboration Πₑ⁽ⁱ⁾, U⁽ⁱ⁾ is then refined by first choosing an unresolved pair [symbol] and then applying a merging heuristic
z,134 =MergeHeuristic [symbol] replicates

[symbol]

The transition [symbol] is resolved as a result, and the entry [symbol] is removed from U⁽ⁱ⁾. If the merging heuristic results in a new location [symbol] then new entries are added to U⁽ⁱ⁾ to reflect unresolved outgoing transitions from the newly added location. If there are no more unresolved pairs in U⁽ⁱ⁺¹⁾, the partial elaboration is also a full elaboration. Thenceforth, the map η is simply propagated on this elaboration until fixed point is reached.

Upon termination, we guarantee that U⁽ⁱ⁾=Ø, i.e., the partial elaboration is a full elaboration and the map η⁽ⁱ⁾ is a fixed point map on this elaboration. Termination of the scheme depends mainly on the nature of the merging heuristic chosen. Since a transition from U is resolved at each step, termination is guaranteed as long as the creation of new locations ceases at some point in the analysis. A simple way to ensure this requirement is to bound the number of replications of each location to a prespecified limit K>0.

Merging Heurstics

Formally a merging heuristic MergeHeuristic (d, d₁, . . . , dₘ) chooses an index 1≦i≦m+1≦K in order to compute the join dᵢ [symbol] d if i≦m or create a new location in the partial elaboration as described above. The key goal of a merging heuristic is that the resulting join add as few extraneous concrete states as possible. Such extraneous states arise since the join is but an approximation of the disjunction of concrete states: γ(d₁)∪γ(d₂) [symbol] γ(d₁␣d₂).

In numerical domains, the states of the program can be viewed as points in n. It is possible to correlate the extraneous concrete states with a distance metric on the abstract objects. Let k(d,d′) be a distance metric defined on Γ and α∈ be a distance cutoff. Let dₘᵢₙ=argmin{k(d,d₁)|1≦i≦m} be the “closest” abstract object to d w.r.t k. The merging heuristic induced by k,α is defined as

$$MergeHeuristic ( d , 〈 {d}_{1} , … , {d}_{m} 〉 ) = \{ \begin{matrix}{d}_{m + 1} , m < K and k ( d , {d}_{min} ) \geq α \\ {d}_{min} , m = K or k ( d , {d}_{min} ) < α\end{matrix}$$

In other words, a new location is spawned whenever it is possible to do so (i.e., m<K) and the closest object is farther than a apart in terms of distance. Failing these, the closest object is chosen as the target of the unresolved transition. The cutoff α ensures that the newly formed disjuncts are initially well separated from the others in terms of the metric k .

The Hausdorff distance, is a commonly used measure of distance between two sets. Given [symbol] , their Hausdorff distance is defined as
Hausdorff

[symbol]

While such metrics provide a good measure of the accuracy of the join, they are hard to compute. We shall use a range-based Hausdorff distance metric.

Range Distance Metric

Let x₁, . . . , xₙ be the program variables and d₁,d₂ be abstract objects. For each variable xᵢ, we shall compute ranges ₁:[p₁,q₁] and ₂:[p₂,q₂] of the values of xᵢ. Such ranges may be efficiently computed for most numerical domains including the polyhedral domain by resorting to linear programming. The ranges are said to be incompatible if one of the two intervals is open in a direction where the other interval is closed, i.e., their Hausdorff distance is unbounded (∞). If the ranges are compatible, the Hausdorff distance is computed based on their end points. The overall distance is a lexicographic tuple m,s where m is the number of dimensions along which d₁,d₂ have incompatible ranges while s is the sum of the distances along the compatible dimensions.

Consider the polyhedra p₁:1≦x≦5Λy≧0 and p₂:−1≦y≦1Λ10≦x≦20. The ranges along x, [1,5] and [10,20] have a Hausdorff distance of 9. On the other hand the ranges along y are [0,∞) and [−1,1] are incompatible. The overall distance between p₁,p₂ is therefore (1,9).

Widening.

Widening is applied to loops formed on the partial elaboration of the CFG by identifying cutpoints, i.e., a set of CFG locations that cut every loop in the CFG. Note that any loop in the partial elaboration results from a loop in the original CFG: If Cₑ be a loop in a partial elaboration Πₑ, then p(Cₑ) is a loop in the original CFG. The converse is not true. Therefore, not all loops in a CFG be replicated as a loop in the partial elaboration. However, once a loop is formed in a partial elaboration, it remains a cycle regardless of the other edges or locations that may be added to it. Furthermore, the post condition computed along such new edges can only accelerate the termination once the widening phase has begun. These observations can be used to simplify the use of widening to that on the base domain, to reuse widening strategies available on the base domain to partial elaborations and finally, to limit the number of applications of widening. This is one of the key advantages of maintaining structural connections among the disjuncts in terms of a partial elaboration.

At this point, while we have discussed and described our invention using some specific examples, those skilled in the art will recognize that our teachings are not so limited. Accordingly, our invention should be only limited by the scope of the claims attached hereto.

1. A computer implemented method for performing path-sensitive program analysis CHARACTERIZED IN THAT:
an elaboration of the program is generated; and
a path-insensitive program analysis is performed using the generated elaboration to produce a path sensitive result on the original program.

2. The computer implemented method of claim 1 wherein
the program is represented as a control flow graph Π: [symbol] where L: is a set of locations (cutpoints); T: a set of transitions (edges), where each transition [symbol] is an edge between the pre-location [symbol] and a post-location [symbol] and each transition is associated with an action that models the changes in the values of program variables using guards and updates; and [symbol] the initial location; Θ is an assertion over \vec{x} representing the initial condition; and
an elaboration of that control flow graph is Πₑ [symbol] where there exists a replication relation, p:Lₑ [symbol] L , relating the nodes L of the original program with Lₑ of the elaboration such that
the initial location [symbol] in Πₑ maps to the initial location [symbol] of [symbol] and
for each outgoing transition [symbol] and for each replication [symbol] such that [symbol] there is an outgoing transition [symbol] such that p(mₑ)=m, and the actions associated with [symbol] and [symbol] are the same.

3. The method of claim 1 further comprising the step of applying heuristic transformations on the original program to generate the elaboration.

4. The method of claim 3 wherein the number of replications of any location are bounded by some apriori limit.

5. The method of claim 1 wherein the elaboration is generated on-the-fly, simultaneously with the analysis in an interleaved manner.

6. The method of claim 3 wherein the elaboration is generated on-the-fly, simultaneously with the analysis in an interleaved manner.

7. The method of claim 6 wherein heuristics based on distance metrics are used to determine target locations of replicated transitions during on-the-fly generation of the elaboration.

8. The method of claim 5 wherein
the elaboration is generated by using one or more path-insensitive analyzers,
the generated elaboration is then used by a different path-insensitive analyzer to generate path sensitive results.

9. The method of claim 6 wherein
the elaboration is generated by using one or more path-insensitive analyzers,
the generated elaboration is then used by a different path-insensitive analyzer to generate path sensitive results.

10. The method of claim 1 wherein said analysis is used to produce a determination indicative of the correctness of the program.

11. The method of claim 3 wherein said analysis is used to produce a determination indicative of the correctness of the program.

12. The method of claim 5 wherein said analysis is used to produce a determination indicative of the correctness of the program.

13. The method of claim 6 wherein said analysis is used to produce a determination indicative of the correctness of the program.

14. The method of claim 1 wherein said analysis is used for simplification of the program.

15. The method of claim 3 wherein said analysis is used for simplification of the program.

16. The method of claim 5 wherein said analysis is used for simplification of the program.

17. The method of claim 6 wherein said analysis is used for simplification of the program.

18. The method of claim 1 wherein said analysis is used for optimizing the program.

19. The method of claim 3 wherein said analysis is used for optimizing the program.

20. The method of claim 5 wherein said analysis is used for optimizing the program.

21. The method of claim 6 wherein said analysis is used for optimizing the program.
